(19) United States
(12) Patent Application Publication
(10) Pub. No.: US 2006/0099960 A1
(43) Pub. Date: May 11, 2006

(54) Method for processing a location request of an area event change

(75) Inventor: Xiaoqin Duan, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/261,744

(22) Filed: Oct. 28, 2005

Related U.S. Application Data
(63) Continuation of application No. PCT/CN04/00702, filed on Jun. 28, 2004.

(30) Foreign Application Priority Data
Jun. 26, 2003 (CN) 03148005.5

(51) Int. Cl. H04Q 7/20

(52) U.S. Cl. 455/456.2; 455/456.1

(57) ABSTRACT

Disclosed is a method for processing location request of change of area event where an LCS system sends a location request of change of area event to target UE. After receiving the location request of change of area event, target UE detects that change of area event has occurred and then returns a LCS area event report to LCS system. After receiving the LCS area event report, LCS system determines whether to provide location estimate of target UE to LCS Client, and if yes, LCS system will locate target UE and then send a LCS area event report with location estimate of target UE to LCS Client; otherwise, LCS system will send the LCS area event report to LCS Client. While LCS Client receives the LCS area event report of target UE, it can also obtain specific location estimate of target UE.

### CROSS-REFERENCES TO RELATED APPLICATIONS

This is a continuation of International Application No. PCT/CN2004/000702, which was filed on Jun. 28, 2004, and which, in turn, claimed the benefit of Chinese Patent Application No. 03148005.5, which was filed on Jun. 26, 2003, the entire disclosures of which are hereby incorporated herein by reference.

### BACKGROUND OF THE DISCLOSURE

1. Field of the Technology

The present invention relates to location techniques and, more particularly, to a method for processing a location request of an area event change.

2. Background of the Invention

For Location Service (LCS) of mobile communication networks, location information of target User Equipment (UE) is obtained by location techniques, where UE demotes UE terminal to be located in mobile communication network, and location information can be either geographical latitude and longitude information or location of local streets. Location estimate of target UE obtained by LCS system may be provided to target UE for self positioning of the target UE, or provided for communication system itself, for zonal charging or operation maintenance. Location information thereof may also be provided to other client application ends requesting for location of target UE, such as organizations and individuals, for supplement service. Therefore, location service is of wide application in terms of emergency assistance, vehicle guidance, intelligent traffic system, work dispatching, team management, mobile yellow page inquiry and network performance enhancement, etc. LCS specifications as well as function mode, structure, state description and message flow of the whole LCS system are illustrated in the 3rd Generation Partnership Project (3GPP).

FIG. 1 is a schematic diagram illustrating logic structure of location service. As shown in FIG. 1, LCS Client 101 requests network 102 with LCS system to provide location estimate of target UE 103. Network 102 with LCS system checks legality authentication of LCS Client 101 to determine whether target UE 103 allows this LCS Client 101 to request for its location information. If LCS Client 101 passes the legality authentication check of network 102 with LCS system, network 102 with LCS system will locate target UE 103 and then provide location estimate of target UE 103 to LCS Client 101. Otherwise, network 102 with LCS system will reject the location information request of LCS Client 101 toward target UE 103.

In LCS system, function logic entities for implementing location service include Gateway Mobile Location Center (GMLC), user data storage server (HLR/HSS), Central Network (CN) and Radio Access Network (RAN). GMLC may further include Requesting GMLC (R-GMLC), Home GMLC (H-GMLC) and Visited GMLC (V-GMLC). R-GMLC is a GMLC for receiving the location information request initiated by LCS Client to target UE, H-GMLC is a GMLC which the target UC belongs to, V-GMLC is the GMLC in the network with LCS system that target UE visits, namely the GMLC that target UE is currently located. R-GMLC, H-GMLC and V-GMLC may be the same physical entity, or be different physical entities.

At present, location request of change of area event is defined in 3GPP specification, and procedure thereof is also defined. Location request of change of area event means that LCS Client pre-specifies target area coverage and trigger events of delivering LCS area event report, like target UE entering, leaving or locating in specified area coverage, delivering LCS area event report to LCS Client, LCS system transmits information, like the specified target area coverage and change of area event, to target UE, then target UE stores the information like the specified target area coverage and change of area event, meanwhile starts corresponding application program, when the application program detects change of area event, like target UE entering, leaving or locating in specified area coverage, LCS Client delivers LCS area event report to the LCS system, and LCS system will forward this LCS area event report to corresponding LCS Client, so as to notify corresponding LCS Client that specified change of area event has occurred. In addition, LCS Client can also appoint target UE to report number of times of delivering LCS area event report, for example, only delivering LCS area event report once, or periodically delivering the report in a specified time range. To sum up, by utilizing location request of change of area event, LCS Client can conveniently define some tracking and monitoring location services, for instance, kid tracking, pet tracking and so on, so that location service can be widely applied in tracking and monitoring field.

Because progress toward location request of change of area event relates to GMLC and CN where target UE is currently located, as well as GMLC and CN that covers the specified target area scope, it is required that GMLC and CN where target UE is currently located as well as GMLC and CN that covers the specified target area scope support progress toward location request of change of area event.

FIG. 2 is a message interaction drawing illustrating location request of change of area event procedure. As shown in FIG. 2, message interaction of location request of change of area event procedure includes the following steps.

Step 201: LCS Client sends LCS Service Request to R-GMLC, where the LCS Service Request carries target UE identifier, the specified target area coverage and change of area event, where change of area event may be target UE entering, leaving or locating in specified area coverage, delivering LCS area event report. This LCS Service Request may also carry effective time range of LCS Service Request, like start time or end time, as well as number of times that LCS Service Request demands LCS area event report to deliver. If it is required to deliver LCS area event report multiply, this LCS Service Request should further carry time interval for periodically delivering LCS area event report. In addition, this LCS Service Request also carries country code of the country that the specified target area coverage belongs to. This LCS Service Request is the above-described location request of change of area event.

Step 202: after receiving LCS Service Request, R-GMLC forwards this LCS Service Request to H-GMLC, then H-GMLC checks legality authentication of LCS Client, so as to determine whether this LCS Service Request is allowed by target UE to provide location information of the target UE for this LCS Client. If LCS Client is legally authenticated, H-GMLC will send LCS Service Request to the V-GMLC that target UE is located. Otherwise, H-GMLC sends authentication failure acknowledgement to R-GMLC, so as to notify R-GMLC to reject the location request of change of area event sent by LCS Client in terms of target UE, R-GMLC notifies LCS Client that the location request of change of area event initiated by this LCS Client is rejected, and location request of change of area event procedure is ended.

Step 203: after receiving LCS Service Request, V-GMLC will transform the specified target area coverage carried in this LCS Service Request into area identifier that can be identified by PLMN network, and send Provide Subscriber Location to CN, where this Provide Subscriber Location carries target UE identifier, specified target area coverage which is transformed into PLMN network geological format as well as the trigger event of delivering LCS area event report; corresponding with information carried in LCS Service Request, this Provide Subscriber Location may carry number of times of delivering LCS area event report, if it is required to deliver LCS area event report multiply, this Provide Subscriber Location should carry time interval for periodically delivering LCS area event report.

Step 204: when detecting that target UE is in idle mode, CN will start paging toward target UE, checking legality authentication of and encoding the target UE, so as to check if this target UE is a legal network subscriber. Further, CN that target UE is currently located can send private check notification to target UE, so as to notify target UE there is a LCS Client requesting its location information, then target LE will personally check whether to allow LCS system to provide location information of this target UE for the LCS Client.

Steps 205 and 206: CN sends Location Area Event Invoke request to target LE through RAN, where information carried by this Location Area Event Invoke request is corresponding with that carried by LCS service request. After receiving Location Area Event Invoke, target UE stores the specified target area coverage and change of area event, if this Location Area Event Invoke requires to multiply deliver LCS area event report, target LE need further store the time interval of periodical deliver LCS area event report, then target UE starts relevant application program of its own and monitors occurrence of change of area event; target UE returns Location Area Event Invoke Acknowledgment to CN, so as to notify CN that current location information request has been accepted and has been processed accordingly.

Steps 207-210: after receiving Location Area Event Invoke Acknowledgment, CN will send Provide Subscriber Location Acknowledgment to V-GMLC, in order to notify V-GMLC that current location information request has been accepted. After receiving Location Area Event Invoke Acknowledgment, V-GMLC sends LCS Service Response to H-GMLC, so as to notify H-GMLC that current location information request has been accepted. After receiving LCS Service Response, H-GMLC sends LCS Service Response to R-GMLC, so as to notify R-GMLC that current location information request has been accepted. After receiving LCS Service Response, R-GMLC sends LCS Service Response to LCS Client, so as to notify LCS Client that current location information request has been accepted.

Steps 211 and 212: when change of area event occurs, namely target UE entering, leaving or being located in specified target area coverage, target UE will send LCS area event report to CN through RAN, so as to notify CN that change of area event has occurred.

Steps 213 and 214: after receiving LCS area event report, CN will send Subscriber Location Report to V-GMLC, so as to notify V-GMLC that the change of area event of target UE has occurred. After receiving Subscriber Location Report, V-GMLC sends Subscriber Location Report Acknowledgment to CN, so as to notify CN that Subscriber Location Report of target UE has been received, here, CN can generate a call detail record for current location information request.

Steps 215-218: after sending Subscriber Location Report Acknowledgment to CN, V-GMLC sends LCS Service Response to H-GMLC, so as to notify H-GMLC that change of area event of target UE has occurred. After receiving LCS Service Response, H-GMLC checks legality authentication of LCS Client, so as to guarantee that the location information provided to the LCS Client is in the scope of authorization of LCS Client. If LCS Client passes the authentication by H-GMLC, H-GMLC will send LCS Service Response to R-GMLC, so as to notify R-GMLC that the change of area event of target UE has occurred. After receiving LCS Service Response, R-GMLC will send LCS Service Response to LCS Client, so as to notify LCS Client that the change of area event of target UE has occurred.

The V-GMLC in steps 211-218 is a GMLC that target UE is currently located and can cover the specified target area coverage. Here, this V-GMLC can be either the same as or different from the GMLC of V-GMLC in steps 202-210. In the same way, the CN in steps 211-218 is a CN that target UE is currently located and can cover the specified target area coverage. Here, this CN may be either the same as or different from the CN in steps 202-210.

If time interval of periodically delivering LCS area event report and number of times of delivering LCS area event report are carried in location request of change of area event, the time interval of delivering LCS area event report, which is reported to CN by target UE, should not be less than the time interval of delivering LCS area event report, which is set in location request of change of area event, and total times of delivering LCS area event report should not exceed the number of times set in location request of change of area event, where each procedure of delivering LCS area event report is the same as that of steps 211-218 by and large.

It can be seen from the above-described progress of location request of change of area event defined in 3GPP that, after target UE detects that change of area event has occurred, LCS system can only provide LCS area event report of target UE to LCS Client, where the LCS area event report can only notify LCS Client that target UE has entered, left or is in a specified target area coverage. If LCS Client requests to obtain not only LCS area event report of target UE, but also detailed location estimate of target UE, the above process is not able to satisfy such requirement of LCS Client, such that LCS Client cannot obtain detailed location estimate of target UE at all.

### SUMMARY OF THE INVENTION

In accordance with one aspect of the disclosure, a method is useful for processing location request of change of area event, such that a location service system can provide not only LCS area event report of target User Equipment (UE) to LCS Client, but also further provide detailed location estimate of target UE to LCS Client according to demand of LCS Client. The method processes location request of change of area event by steps including:

(A) LCS system sending location request of change of area event to target UE, after receiving location request of change of area event and detecting that change of area event has occurred, target UE returning LCS area event report to LCS system;

(B) after receiving LCS area event report, LCS system determining whether to provide location estimate of target UE to LCS Client, if yes, executing step (C), otherwise, LCS system just sending LCS area event report to LCS Client and ending process of current location request of change of area event;

(C) LCS system locating target UE and then sending LCS area event report with location estimate of target UE to LCS Client.

In some cases, step (B) includes steps of, after receiving LCS area event report, CN in LCS system determining whether there is indication for locating target UE in the LCS area event report sent by target UE, if yes, executing step (C), otherwise, LCS system just sending LCS area event report to LCS Client and ending process of current location request of change of area event. Step (C) may include a CN in LCS system locating the target UE and LCS system sending a LCS area event report with location estimate of target UE to LCS Client.

In some cases, step (B) may include, after receiving LCS area event report, GMLC in LCS system determining whether indication for locating target UE carried in location request of change of area event has stored in the GMLC, and if yes, executing step (C), otherwise, LCS system just sending LCS area event report to LCS Client and ending process of current location request of change of area event. Step (C) may then include GMLC in LCS system locating the target UE and LCS system sending a LCS area event report with location estimate of target UE to LCS Client.

The indication for locating target UE may be or involve Locating instruction that is used to request LCS system to locate target UE.

Alternatively or additionally, the indication for locating target UE further includes Quality of Service parameters corresponding to requirement of target UE.

The LCS system locating target UE in step (C) may include or involve LCS system locating target UE according to the Quality of Service parameters.

The location estimate of target UE may be or involve the obtained location estimate of target UE after LCS succeeds in locating target UE.

The location estimate of target UE may be or involve error code indicating that LCS system fails in locating target UE.

The location estimate of target UE may further include the failure reason.

The LCS area event report in step A may further carry information of the area coverage where target UE is located.

In some cases, before step (A), the method further includes steps involving or including:

(A1) LCS system receiving the location request of change of area event toward target UE initiated by LCS Client;

(A2) LCS system determining whether information of the area coverage where target UE is located provided by target UE can meet requirement for locating the target UE which is set by the LCS Client, and if yes, executing step (A3), otherwise, executing step (A);

(A3) LCS system sending a location request of change of area event with information instruction to target UE, target UE storing the information instruction after receiving the location request of change of area event, when detecting that change of area event has occurred, target UE returning LCS area event report with information of the area coverage where target UE is located to LCS system, LCS system forwarding this LCS area event report with information of the area coverage where target UE is located to LCS Client and then ending current progress toward the location request of change of area event.

Determining whether information of the area coverage where target UE is located provided by target UE can meet requirement for locating the target UE which is set by the LCS Client, including or involving determining whether information of the area coverage where target UE is located provided by target UE can meet quality parameter requirement carried in the location request of change of area event.

In some cases, before step (A2), the method further includes or involves LCS system determining whether to provide location estimate of target UE to LCS Client, and if yes, executing step (A2); otherwise, LCS system sending a location request of change of area event to target UE, after receiving the location request of change of area event and detecting that change of area event has occurred, target UE returning LCS area event report to LCS system, LCS system forwarding this LCS area event report to LCS Client and then ending current progress toward the location request of change of area event.

Determining whether to provide location estimate of target UE to LCS Client may include or involve determining whether the reported LCS area event report by target UE carries indication for locating target UE.

Alternatively or additionally, determining whether to provide location estimate of target UE to LCS Client may include or involve determining whether LCS system itself stores indication for locating target UE carried in the location request of change of area event.

In accordance with another aspect of the disclosure, LCS Client may send a location request of change of area event with locating instruction to target UE, to request LCS system to provide location estimate of target UE while sending LCS area event report to LCS Client, so that while LCS system is providing LCS area event report of target UE to LCS Client, it may further provide specific location estimate of target UE on demand of LCS Client. Consequently, LCS Client can not only learn about occurrence of trigger location report event of target UE, but also obtain specific location estimate of target UE. In addition, multiple embodiments are provided in the present invention for flexible selections.

### BRIEF DESCRIPTION OF THE DRAWINGS

FIG. 1 is a schematic diagram illustrating logic structure for implementing location service;

FIG. 2 is a message interaction depiction illustrating progress of location request of change of area event in existing technology;

FIG. 3 is a flowchart illustrating progress of location request of change of area event in accordance with one aspect of the disclosure;

FIG. 4 illustrates message interaction of location request of change of area event in accordance with one embodiment;

FIG. 5 illustrates message interaction of location request of change of area event in accordance with another embodiment;

FIG. 6 is a flowchart illustrating another progress of location request of change of area event in accordance with one aspect of the disclosure; and

FIG. 7 illustrates message interaction of location request of change of area event in accordance with one embodiment.

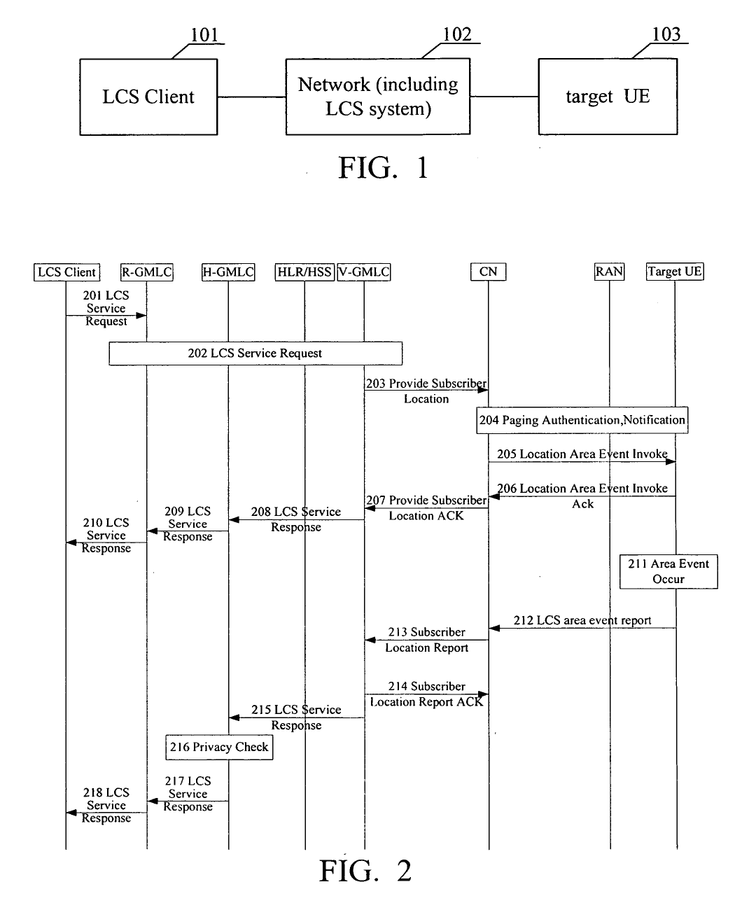

### DETAILED DESCRIPTION OF PREFERRED EMBODIMENTS

In accordance with one aspect, LCS Client sends a location request of change of area event to LCS system and the request thereof further carries a locating instruction to request LCS system to provide location estimate of target UE, when target UE detects that change of area event has occurred, after target UE returns the LCS area event report to LCS system, through determining whether the location request of change of area event carries a locating instruction, LCS system performs subsequent progress to the location request of change of area event.

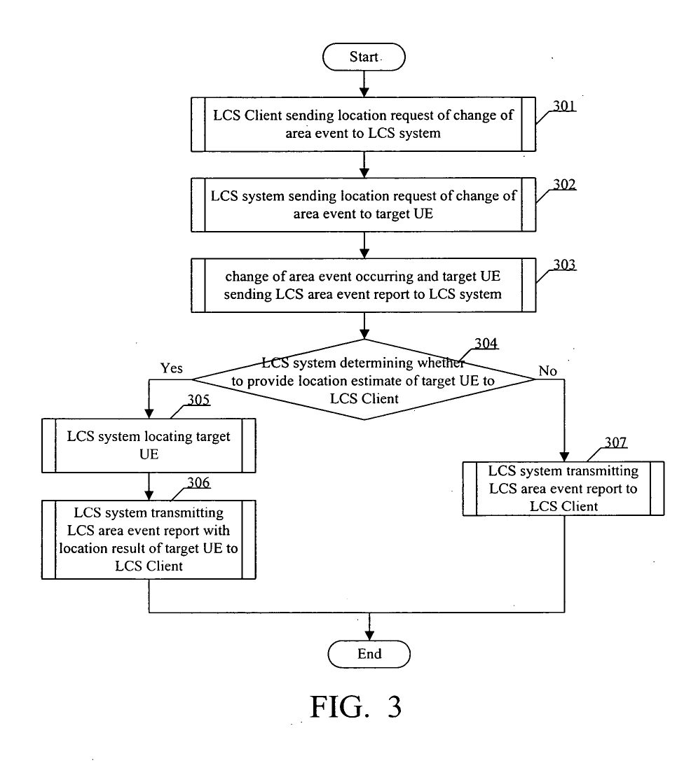

FIG. 3 is a flowchart illustrating progress of location request of change of area event in the present invention. As shown in FIG. 3, progress of location request of change of area event may include or involve the following steps.

Steps 301-303: LCS Client sending a location request of change of area event to LCS system; after receiving the location request of change of area event, LCS system sends the location request of change of area event to target UE; after receiving the location request of change of area event, target UE stores the change of area event carried in location request of change of area event. When detecting occurrence of change of area event, target UE will return LCS area event report to LCS system.

Step 304: after receiving the LCS area event report, LCS system will determine whether to provide location estimate of target UE to LCS Client, namely determining whether the location request of change of area event carries locating instruction, and if yes, executing step 305; otherwise, executing step 307.

Steps 305 and 306: LCS system locates the target UE, then sends the LCS area event report with location estimate of target UE to LCS Client and ends the progress of location request of change of area event. If LCS system succeeds in locating target UE, it will send a LCS area event report with location estimate of target UE; if LCS system fails in locating target UE, it will send a LCS area event report with failure reason.

Step 307: after receiving LCS area event report, LCS system sends this LCS area event report to LCS Client.

After LCS system receives LCS area event report of target UE, there are two ways to determine whether to provide location estimate of target UE to LCS Client, one way is that target UE stores the locating instruction carried in location request of change of area event; the other way is that LCS system stores the locating instruction carried in location request of change of area event.

Target UE stores the locating instruction carried in location request of change of area event, it means that LCS system transmits all contents in location request of change of area event, which is sent by LCS Client, to target UE for storage. When detecting that change of area event has occurred, target UE will return LCS area event report to LCS system, according to relevant information of the stored location request of change of area event, target UE determines that this LCS area event report carries locating instruction from LCS Client, then LCS system will locate target UE according to the locating instruction carried in LCS area event report and return LCS area event report with location estimate of target UE to LCS Client at last.

LCS system stores the locating instruction carried in location request of change of area event, it means that after LCS system receives a location request of change of area event sent by LCS Client, it will store the locating instruction carried in this location request of change of area event, and then transmit other relevant contents of change of area event other than locating instruction carried in the location request of change of area event to target UE. When detecting that change of area event has occurred, target UE will return LCS area event report to LCS system, after receiving the LCS area event report, LCS system determines to provide location estimate of target UE to LCS Client according to self-stored relevant information of the location request of change of area event, then LCS system locates the target UE and returns LCS area event report with location estimate of target UE to LCS Client at last.

While a location request of change of area event carries locating instruction, it can further include relevant Quality of Service (QoS) parameters concerning location estimate of target UE, like locating precision, error range, response time, etc.

Specific procedure of the two ways will be described in detail hereinafter.

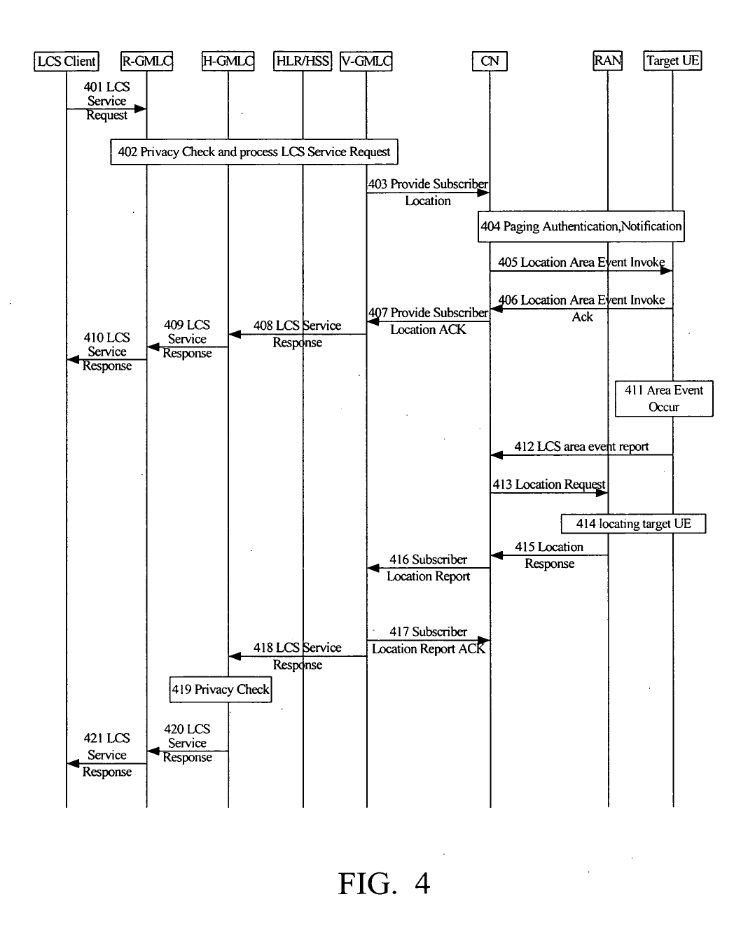

FIG. 4 is a drawing illustrating message interaction of location request of change of area event in an embodiment of the present invention. As shown in FIG. 4, message interaction of location request of change of area event procedure includes the following steps.

Step 401: LCS Client sends a LCS Service Request to R-GMLC, where this LCS Service Request carries target UE identifier, specified target area coverage and change of area event, thereby change of area event can be used to trigger report LCS area event report when target UE enters, leaves or is located in a specified area coverage; this LCS Service Request also carries locating instruction, which requests LCS system to provide location estimate of target UE while LCS system is sending LCS area event report to LCS Client, this LCS Service Request may further carry relevant QoS parameters concerning target UE location information, which indicates LCS Client's demand that LCS system provide location estimate of target UE; this LCS Service Request may carry effective time span, like start time and end time, as well as number of times for reporting LCS area event report on demand of LCS Service Request, if it is required to report LCS area event report multiply, this LCS Service Request needs to carry time interval for periodically reporting LCS area event report. This LCS Service Request is right the location request of change of area event.

Steps 402-404 are essentially the same as steps 202-204, just that each interactive message hereby carries a locating instruction and may further carry relevant QoS parameters concerning location estimate of target UE.

Steps 405 and 406: CN sends a Location Area Event Invoke request to target UE through RAN, where information carried in Location Area Event Invoke and that carried in LCS Service Request are corresponding. After receiving Location Area Event Invoke, target UE stores the specified target area coverage/change of area event and locating instruction, if it is required to report LCS area event report multiply, target UE needs to store time interval for periodically reporting LCS area event report, if Location Area Event Invoke also carries relevant QoS parameters concerning locating instruction, target UE also needs to store the QoS parameters thereof, and then target UE starts up relevant application program of its own to monitor occurrence of change of area event; target UE sends a Location Area Event Invoke Acknowledgment to CN to notify CN that current location request of change of area event has been accepted and processed accordingly.

Steps 407-410 are essentially the same as steps 207-210.

Steps 411 and 412: when change of area event occurs, namely when UE enters, leaves or is located in a specified area coverage, target UE will send a LCS area event report to CN through RAN, where the LCS area event report carries locating instruction and may further carry QoS parameters, in order to notify CN that change of area event has occurred, and further notify CN to provide location estimate of target UE while CN is sending LCS area event report to LCS Client.

Steps 413-415: after receiving LCS area event report, according to the locating instruction carried in LCS area event report reported by UE, CN determines that LCS Client demands to be provided with location estimate of target UE besides sending LCS area event report to the LCS Client, so CN sends a Location Request to RAN for locating target UE, where the Location Request carries relevant QoS parameters concerning the locating operation; after receiving Location Request, RAN locates target UE according to requirements of QoS parameters, and then sends a Location Report with location estimate of target UE to CN. If RAN succeeds in locating target UE, it will send a Location Report with location estimate of target UE to CN; if RAN fails in locating target UE, it will send a Location Report with failure reason to CN. The failure reason may be that requirements of QoS parameters cannot be satisfied, and so on.

Step 416: after receiving the Location Report with location estimate of target UE, CN will send a Subscriber Location Report of target UE with location estimate of target UE to V-GMLC, so as to notify V-GMLC that change of area event of target UE has occurred and target UE is located already.

Steps 417-421 are essentially the same as steps 214-218, just that each interactive message hereby carries location estimate of target UE.

The V-GMLC in steps 411-421 is a GMLC where target UE is currently located and which can cover the specified target area coverage, and the V-GMLC hereby can be the same GMLC as that in steps 402-410, or be different ones otherwise; in the same way, the CN in steps 411-421 is a CN where target UE is currently located and which can cover the specified target area coverage, and the CN hereby can be the same CN as that in steps 402-410, or be different ones otherwise.

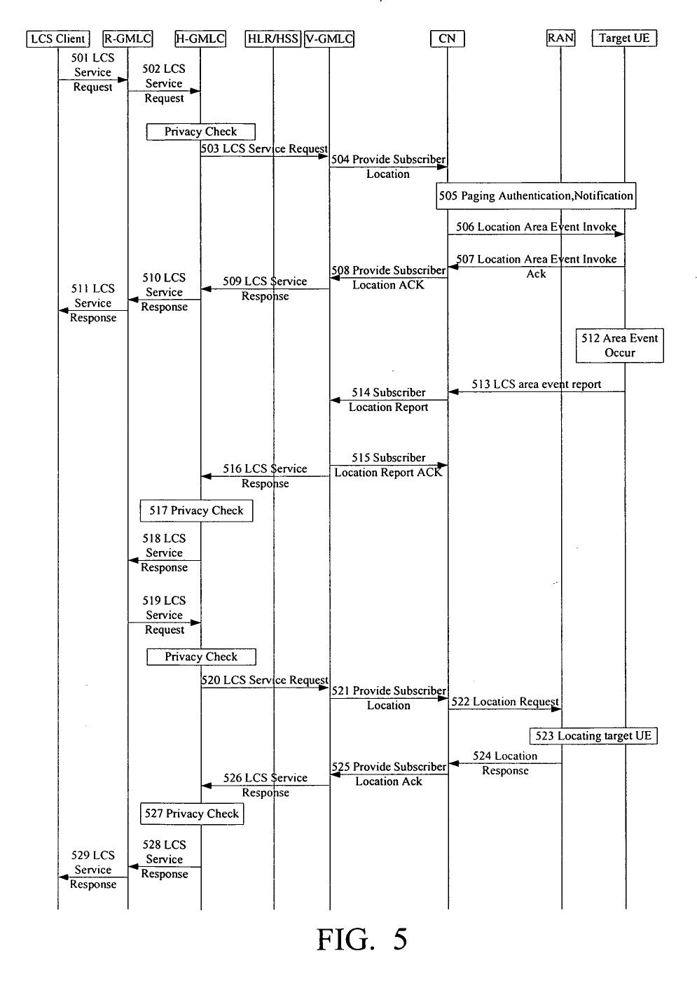

FIG. 5 is a drawing illustrating message interaction of location request of change of area event in another embodiment of the present invention. As shown in FIG. 5, message interaction of location request of change of area event procedure includes the following steps.

Step 501 is essentially the same as step 401.

Steps 502 and 503: after receiving LCS Service Request, R-GMLC stores the locating instruction and relevant QoS parameters carried in this LCS Service Request, and then forwards this LCS Service Request to H-GMLC, where H-GMLC will check legality authentication of LCS Client to determine whether target UE allows LCS system to provide location estimate of target UE to this LCS Client, if LCS Client passes the legality authentication check, H-GMLC will send LCS Service Request to V-GMLC, where this LCS Service Request does not carry locating instruction or relevant QoS parameters; otherwise, H-GMLC will return legality authentication check failed response, R-GMLC will reject the location request of change of area event toward target UE and end current process of location request of change of area event.

Steps 504-518 are essentially the same as steps 203-217.

Steps 519-523: after receiving LCS Service Request, according to the storing locating instruction carried in the LCS Service Request, R-GMLC determines that LCS Client demands LCS system to provide location estimate of target UE besides sending LCS area event report to it, so R-GMLC generates an instant mode location information request, namely LCS Service Request, and sends this LCS Service Request to H-GMLC, where this LCS Service Request carries target UE identifier and location-relevant QoS parameters, to request to locate target UE. After receiving LCS Service Request, H-GMLC may further check legality authentication of LCS Client to determine whether target UE allows LCS system to provide location estimate of target UE to this LCS Client, if LCS Client passes the legality authentication check, H-GMLC will send LCS Service Request to V-GMLC, after receiving the LCS Service Request, V-GMLC will send Provide Subscriber Location to CN, where the Provide Subscriber Location carries target UE identifier and location-relevant QoS parameters. After receiving Provide Subscriber Location, CN sends Location Request to corresponding RAN, where the Location Request carries target UE identifier and location-relevant QoS parameters; after receiving Location Request, RAN locates target UE according to requirement of QoS parameters, and then sends a Location Report with location estimate of target UE to CN. If RAN succeeds in locating target UE, it will send a Location Report with location estimate of target UE to CN; if RAN fails in locating target UE, it will send a Location Report with failure reason to CN.

Steps 524-529 are essentially the same as steps 416-421.

The V-GMLC in steps 511-529 is a GMLC where target UE is currently located and which can cover the specified target area coverage, and the V-GMLC hereby can be the same GMLC as that in steps 502-510, or be different ones otherwise; in the same way, the CN in steps 511-529 is a CN where target UE is currently located and which can cover the specified target area coverage, and the CN hereby can be the same CN as that in steps 502-510, or be different ones otherwise.

In the above procedure, the locating instruction carried in location request of change of area event can also be stored in H-GMLC and then H-GMLC locates target UE.

In the above procedure, the location request of change of area event, which is sent by LCS Client to LCS system, may not carry locating instruction, and target UE provides more of its own information while reporting LCS area event report, for instance, such as information of the area coverage where target UE is located, LCS system provides the information from target UE to LCS Client while sending LCS area event report to LCS Client.

Because target UE can obtain some information of the area coverage where target UE is located, such as Cell ID, Location Area and so on, LCS Client requests target UE to provide location estimate of target UE besides sending LCS area event report to it, in this way, LCS system can pre-judge whether information of the area coverage where target UE is located obtained by target UE can satisfy quality of service requirement demanded by LCS Client, if yes, LCS system can demand target UE to provide information of the area coverage where target UE is located besides to report LCS area event report, and then while LCS system is sending LCS area event report to LCS Client, it will also provide information of the area coverage where target UE is located to LCS Client; otherwise, LCS system can choose any processing way of the above two.

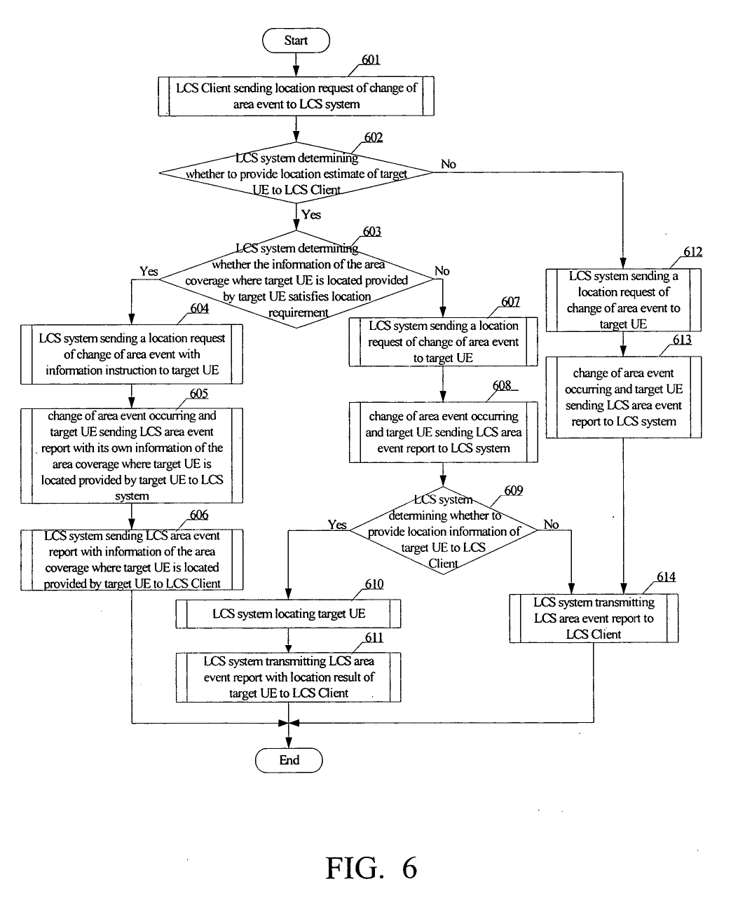

FIG. 6 is a flowchart illustrating another progress of location request of change of area event in the present invention. As shown in FIG. 6, message interaction of location request of change of area event procedure includes the following steps.

Steps 601 and 602: LCS Client sends a location request of change of area event to LCS system; after receiving the location request of change of area event, LCS system determines whether to provide location estimate of target UE to LCS Client, namely determining whether the location request of change of area event started toward target UE by LCS Client carries locating instruction, and if yes, executing step 603; othervise, executing step 612.

Step 603: LCS system determines whether the information of area coverage where target UE is located provided by target UE can satisfy locating requirement of LCS Client, if yes, executing step 604; otherwise, executing step 607.

Steps 604-606: LCS system sends a location request of change of area event with locating instruction to target UE; after receiving the location request of change of area event, target UE stores change of area event and information indication carried in the location request of change of area event. When detecting occurrence of change of area event, target UE returns a LCS area event report with information of area coverage where it is located to LCS system, LCS system sends the LCS area event report with information of area coverage where target UE is located to LCS Client and ends current process toward location request of change of area event.

Steps 607-609: after receiving the location request of change of area event, LCS system sends the location request of change of area event to target UE; after receiving the location request of change of area event, target UE stores change of area event carried in the location request of change of area event. When detecting occurrence of change of area event, target UE returns the LCS area event report to LCS system. After receiving the LCS area event report, LCS system determines whether to provide location estimate of target UE to LCS Client, namely determining whether the location request of change of area event started toward target UE by LCS Client carries locating instruction, and if yes, executing step 610; otherwise, executing step 614.

Steps 610 and 611: LCS system locates target UE, sends the LCS area event report with location estimate of target UE to LCS Client and then ends current process toward the location request of change of area event. If LCS system succeeds in locating target UE, it will send a LCS area event report with location estimate of target UE to LCS Client; if LCS system fails in locating target UE, it will send a LCS area event report with failure reason to LCS Client.

Steps 612 and 611: after receiving the location request of change of area event, LCS system sends the location request of change of area event to target UE; after receiving the location request of change of area event, target UE stores change of area event carried in the location request of change of area event. When detecting occurrence of change of area event, target UE returns the LCS area event report to LCS system and then step 614 is executed.

Step 614: after receiving the LCS area event report, LCS system sends the LCS area event report to the LCS Client.

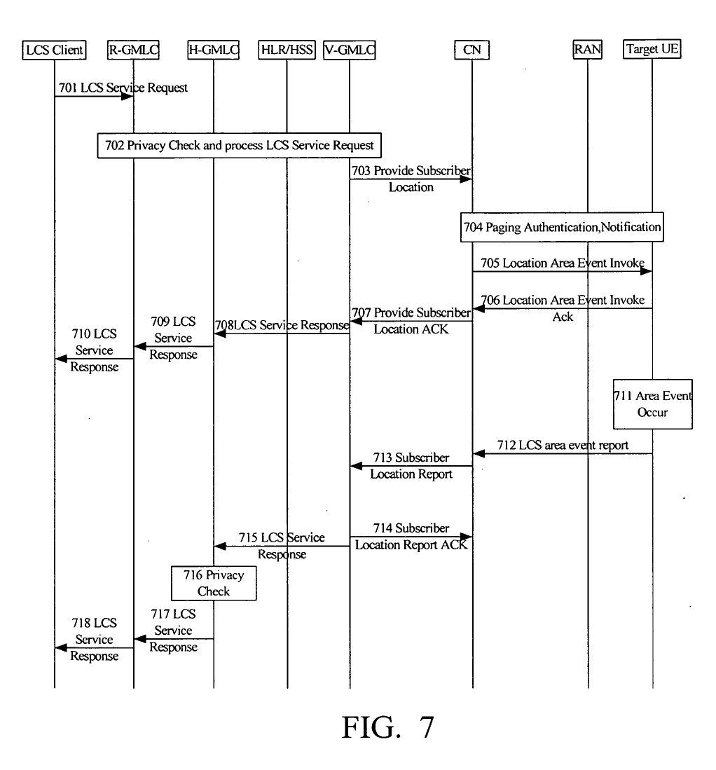

FIG. 7 illustrates message interaction of location request of change of area event in the third embodiment of the present invention. As shown in FIG. 7, message interaction of location request of change of area event procedure includes the following steps.

Step 701 is essentially the same as step 401.

Step 702: after receiving LCS Service Request, R-GMLC forwards this LCS Service Request to H-GMLC, H-GMLC checks legality authentication of LCS Client to determine whether target UE allows LCS system to provide location estimate of target UE to this LCS Client, if LCS Client passes the legality authentication check, H-GMLC will send LCS Service Request to V-GMLC, in this step, R-GMLC or H-GMLC or V-GMLC determines that information of area coverage where target UE is located provided by target UE can satisfy locating requirement of LCS Client toward target UE, for instance, it is determined that information of area coverage where target UE is located provided by target UE can meet QoS parameter requirement carried in LCS Service Request, then step 703 will be executed; if R-GMLC or H-GMLC or V-GMLC determines that information of area coverage where target UE is located provided by target UE cannot satisfy locating requirement of LCS Client toward target UE, R-GMLC or H-GMLC or V-GMLC will follow the steps 403-421 or steps 503-526 to process the location request of change of area event which is started toward target UE by LCS Client. If LCS Client does not pass the legality authentication check, H-GMLC will return legality authentication check failed response to R-GMLC, then R-GMLC will reject the location request of change of area event toward target UE and end current process of location request of change of area event.

Steps 703 and 704 are essentially the same as steps 203 and 204, just that each interactive message hereby carries information indication that requests target UE to provide information of area coverage where it is located.

Step 705: CN sends Location Area Event Invoke to target UE through RAN, where information carried in this Location Area Event Invoke and that carried in LCS Service Request are corresponding, and information indication is further comprised thereof. After receiving the Location Area Event Invoke, target UE stores the information indication and starts up its own relevant application program to monitor occurrence of change of area event.

Steps 706-710 are essentially the same as steps 206-210.

Steps 711 and 712: when change of area event occurs, namely when target UE enters, leaves or is located in the specified target area coverage, target UE will send a LCS area event report to CN through RAN, where this LCS area event report carries information of the area coverage where target UE is located, to notify CN that change of area event has occurred, and then provides information of the area coverage where target UE is located to CN.

Steps 713-718 are essentially the same as steps 213-218, just that each message carries information of the area coverage where target UE is located.

The V-GMLC in steps 711-718 is a GMLC where target UE is currently located and which can cover the specified target area coverage, and the V-GMLC hereby can be the same GMLC as that in steps 702-710, or be different one otherwise; in the same way, the CN in steps 711-718 is a CN where target UE is currently located and which can cover the specified target area coverage, and the CN hereby can be the same CN as that in steps 702-710, or be different one otherwise.

In summary, the above description is directed to certain embodiments of the present invention, and is not intended to confine protection or the scope of the present invention thereto.

1. A method for processing location request of change of area event, comprising the steps of:
(A) an LCS system sending location request of change of area event to target UE, after receiving the location request of change of area event and detecting the change of area event has occurred, the target UE returning an LCS area event report to the LCS system;
(B) after receiving the LCS area event report, the LCS system determining whether to provide a location estimate of the target UE to an LCS Client, and if yes, executing step (C), otherwise, the LCS system sending the LCS area event report to the LCS Client and ending process of current location request of change of area event; and,
(C) the LCS system locating the target UE and then sending the LCS area event report with the location estimate of the target UE to the LCS Client.

2. The method according to claim 1, wherein:
said step (B) comprises:
after receiving the LCS area event report, a CN in the LCS system determining whether there is indication for locating the target UE included in the LCS area event report sent by the target UE, and if yes, executing step (C), otherwise, the LCS system sending the LCS area event report to the LCS Client and ending process of current location request of the change of area event; and,
said step (C) comprises:
the CN in the LCS system locating the target UE and the LCS system sending a LCS area event report with location estimate of the target UE to the LCS Client.

3. The method according to claim 2, wherein said indication for locating the target UE comprises locating indication that is used to request the LCS system to locate the target UE.

4. The method according to claim 2, wherein said location estimate of the target UE comprises the obtained location estimate of the target UE after the LCS system locating the target UE successfully.

5. The method according to claim 2, wherein said location estimate of the target UE comprises Error code indicating that the LCS system fails in locating the target UE.

6. The method according to claim 1, wherein:
said step (B) comprises:
after receiving the LCS area event report, a GMLC in the LCS system determining whether indication for locating the target UE carried in location request of the change of area event has stored in the GMLC, and if yes, executing step (C), otherwise, the LCS system sending the LCS area event report to the LCS Client and ending process of current location request of the change of area event;
said step (C) comprises:
the GMLC in the LCS system locating the target UE and the LCS system sending a LCS area event report with location estimate of the target UE to the LCS Client.

7. The method according to claim 6, wherein said location estimate of the target UE comprises the obtained location estimate of the target UE after the LCS system locating the target UE successfully.

8. The method according to claim 6, wherein said location estimate of the target UE comprises Error code indicating that the LCS system fails in locating the target UE.

9. The method according to claim 6, wherein said indication for locating the target UE comprises locating indication that is used to request the LCS system to locate the target UE.

10. The method according to claim 9, wherein said indication for locating the target UE further comprises Quality of Service parameters corresponding to requirement of the target UE.

11. The method according to claim 10, wherein said the LCS system locating the target UE in step (C) comprises the LCS system locating the target UE according to said Quality of Service parameters.

12. The method according to claim 6, wherein said location estimate of the target UE comprises the obtained location estimate of the target UE after the LCS system locating the target UE successfully.

13. The method according to claim 6, wherein said location estimate of the target UE comprises Error code indicating that the LCS system fails in locating the target UE.

14. The method according to claim 13, wherein said location estimate of the target UE further comprising a failure reason.

15. The method according to claim 1, wherein said LCS area event report in step (A) further comprises carrying information of the area coverage where the target UE is located.

16. The method according to claim 1, further comprising before said step (A):
(A1) LCS system receiving the location request of the change of area event toward the target UE initiated by the LCS Client;
(A2) the LCS system determining whether information of the area coverage where the target UE is located provided by the target UE can meet requirement for locating the target UE which is set by the LCS Client, and if yes, executing step (A3), otherwise, executing step (A);
(A3) the LCS system sending a location request of the change of area event with information instruction to the target UE, the target UE storing said information instruction after receiving the location request of the change of area event, when detecting that the change of area event has occurred, the target UE returning an LCS area event report with information of the area coverage where the target UE is located to the LCS system, the LCS system forwarding the LCS area event report with information of the area coverage where the target UE is located to the LCS Client and then ending current progress toward the location request of the change of area event.

17. The method according to claim 16, wherein said determining whether information of the area coverage where the target UE is located provided by the target UE can meet requirement for locating the target UE which is set by the LCS Client, comprises determining whether information of the area coverage where the target UE is located provided by the target UE can meet quality of service parameter requirement carried in the location request of the change of area event.

18. The method according to claim 16, further comprising before said step (A2) the LCS system determining whether to provide location estimate of the target UE to the LCS Client, and if yes, executing step (A2); otherwise, the LCS system sending a location request of change of area event to the target UE, after receiving the location request of the change of area event and detecting that the change of area event has occurred, the target UE returning the LCS area event report to the LCS system, the LCS system forwarding the LCS area event report to the LCS Client and then ending current progress toward the location request of the change of area event.

19. The method according to claim 18, wherein said determining whether to provide location estimate of the target UE to the LCS Client, comprises determining whether the reported LCS area event report by the target UE carries indication for locating the target UE.

20. The method according to claim 18, wherein said determining whether to provide location estimate of the target UE to the LCS Client comprises determining whether the LCS system itself stores indication for locating the target UE carried in the location request of change of area event.

21. The method according to claim 1, wherein said determining whether to provide location estimate of the target UE to the LCS Client, comprises determining whether the reported LCS area event report by the target UE carries indication for locating the target UE.

22. The method according to claim 1, wherein said determining whether to provide location estimate of the target UE to the LCS Client comprises determining whether the LCS system itself stores indication for locating the target UE carried in the location request of the change of area event.
